(19) United States
(12) Patent Application Publication
(10) Pub. No.: US 2021/0209559 A1
(43) Pub. Date: Jul. 8, 2021

(54) TABLE GRID WITH MULTI-LEVEL HEADER AND VALUE

(71) Applicant: ADP, LLC, Roseland, NJ (US)

(72) Inventors: Abhishek Prasad, Hyderabad (IN); Sri Hari A N R, Hyderabad (IN); Devesh Jagatram, Pune (IN)

(21) Appl. No.: 16/735,429

(22) Filed: Jan. 6, 2020

(51) Int. Cl. G06Q 10/10; G06Q 10/06; G06F 3/0482; G06F 3/0488

(52) U.S. Cl. CPC G06Q 10/1053; G06F 3/04886; G06F 3/0482; G06Q 10/063114

(57) ABSTRACT

A computer system, method, and computer program product for accessing and displaying data values across user-customizable data dimensions. A set of controls is displayed in a first area of a graphical user interface. A table of data is displayed in a second area of the graphical user interface. A bifurcated list of dimension identifiers is displayed in response to receiving user input that selects the column customization. In response to receiving user input moving a dimension identifier to a first partition of the bifurcated list, the corresponding data dimension is displayed in a static panel of the second area of the graphical user interface. In response to receiving user input moving a dimension identifier to a second partition of the bifurcated list, the corresponding data dimension is displayed in a scrollable panel of the second area of the graphical user interface.

### BACKGROUND INFORMATION

### 1. Field

The present disclosure relates generally to an improved computer system. Still more particularly, the present disclosure relates to a method, an apparatus, a system, and a computer program product for accessing and displaying data values across user-customizable data dimensions depicted according to an illustrative embodiment.

### 2. Background

One of the problems facing the users of computing devices with large amounts of data relative to display screen real estate is how to allow the user to navigate quickly and efficiently to access data. In conventional user interfaces, a user may need to horizontally scroll around, switching views many times to find the right data/functionality.

Often, the absolute volume of information precludes a user from simultaneously viewing relevant information. Information displayed in disparate columns of multiple column grids can require a huge horizontal scroll, often hiding columns of information as new columns are scrolled into and out of view. For example, when the user scrolls to columns on the left side of a data grid, columns on the far right side of the data grid can be hidden under the horizontal scroll. The user cannot relate which row and label to refer as the primary detail is hidden by the scroll.

For example, in a human resources environment, compensation data for company employees often have numerous parameters, fields, figures, and values that must be accessed and compared when performing human resource operations. Because of the large number of columns and rows in which relevant data is displayed, the user must often scroll tables of relevant information to display old data, new data, or comparative data. However, the scrolling process often obscures relevant data, making a comparison between different data values more difficult than desired, and making it harder for a user to appreciate correlations between different data values.

Therefore, it would be desirable to have a method and apparatus that take into account at least some of the issues discussed above, as well as other possible issues. For example, it would be desirable to have a method and apparatus that overcome a technical problem with a graphical user interface that solves the complex problem of displaying a massive data grid.

### SUMMARY

An embodiment of the present disclosure provides a method for accessing and displaying data values across user-customizable data dimensions. The process displays a set of controls in a first area of a graphical user interface. The set of controls comprises a column customization. The process displays a table of data, and a second area of the graphical user interface. The table comprises a set of data values displayed across a set of data dimensions. In response to receiving user input that selects the column customization, the process displays a bifurcated list of dimension identifiers. Each of the dimension identifiers corresponds to a different one of the set of data dimensions. In response to receiving user input moving a dimension identifier to a first partition of the bifurcated list, the process displays the corresponding data dimension in a static panel of the second area of the graphical user interface. In response to receiving user input moving a dimension identifier to a second partition of the bifurcated list, the process displays the corresponding data dimension in a scrollable panel of the second area of the graphical user interface.

Another embodiment of the present disclosure provides a computer system for accessing and displaying data values across user-customizable data dimensions. The computer system includes a hardware processor, a display device, and a graphical user interface engine. The graphical user interface engine controls the display device to display a set of controls in a first area of a graphical user interface. The set of controls comprises a column customization. The graphical user interface engine controls the display device to display a table of data, and a second area of the graphical user interface. The table comprises a set of data values displayed across a set of data dimensions. In response to receiving user input that selects the column customization, the graphical user interface engine controls the display device to display a bifurcated list of dimension identifiers. Each of the dimension identifiers corresponds to a different one of the set of data dimensions. In response to receiving user input moving a dimension identifier to a first partition of the bifurcated list, the graphical user interface engine controls the display device to display the corresponding data dimension in a static panel of the second area of the graphical user interface. In response to receiving user input moving a dimension identifier to a second partition of the bifurcated list, the graphical user interface engine controls the display device to display the corresponding data dimension in a scrollable panel of the second area of the graphical user interface.

Yet another embodiment of the present disclosure provides a computer program product for accessing and displaying data values across user-customizable data dimensions. The computer program product comprises a computer-readable-storage media program code stored thereon. The program code includes code for displaying a set of controls in a first area of a graphical user interface. The set of controls comprises a column customization. The program code includes code for displaying a table of data, and a second area of the graphical user interface. The table comprises a set of data values displayed across a set of data dimensions. The program code includes code for displaying a bifurcated list of dimension identifiers in response to receiving user input that selects the column customization. Each of the dimension identifiers corresponds to a different one of the set of data dimensions. The program code includes code for displaying the corresponding data dimension in a static panel of the second area of the graphical user interface. In response to receiving user input, a dimension identifier is moved to a first partition of the bifurcated list. The program code includes code for displaying the corresponding data dimension in a scrollable panel of the second area of the graphical user interface. In response to receiving user input, a dimension identifier is moved to a second partition of the bifurcated list.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of an information processing environment in accordance with an illustrative embodiment;

FIG. 3 is a first illustration of a graphical user interface in accordance with an illustrative embodiment;

FIG. 4 is an illustration of different graphical control elements for a graphical user interface in accordance with an illustrative embodiment;

FIG. 5 is an illustration of different graphical control elements in context with a graphical user interface in accordance with an illustrative embodiment;

FIG. 6 is a flowchart of a process for accessing and displaying data values across user-customizable data dimensions in accordance with an illustrative embodiment;

FIG. 7 is a flowchart of additional processing steps for accessing and displaying data values across user-customizable data dimensions depicted according to an illustrative embodiment;

FIG. 8 is a flowchart of additional processing steps for accessing and displaying data values across user-customizable data dimensions in accordance with an illustrative embodiment;

FIG. 9 is a flowchart of additional processing steps for accessing and displaying data values across user-customizable data dimensions in accordance with an illustrative embodiment;

FIG. 10 is a flowchart of additional processing steps for accessing and displaying data values across user-customizable data dimensions in accordance with an illustrative embodiment;

FIG. 11 is a flowchart of additional processing steps for accessing and displaying data values across user-customizable data dimensions in accordance with an illustrative embodiment;

FIG. 12 is a flowchart of additional processing steps for accessing and displaying data values across user-customizable data dimensions in accordance with an illustrative embodiment; and

FIG. 13 is a block diagram of a data processing system in accordance with an illustrative embodiment.

### DETAILED DESCRIPTION

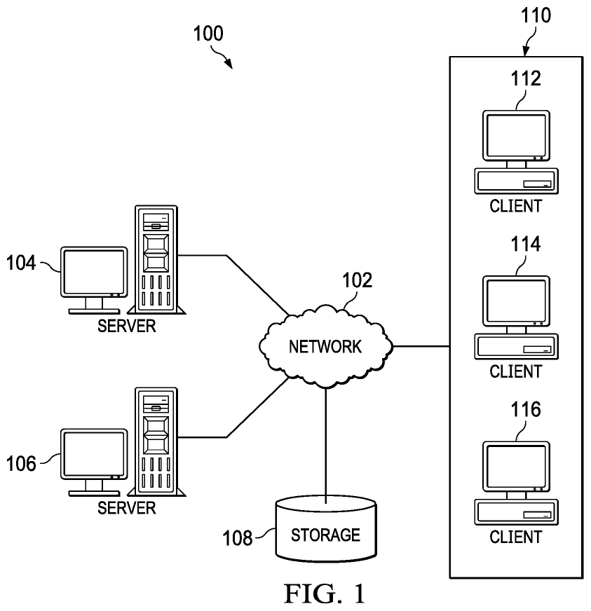

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

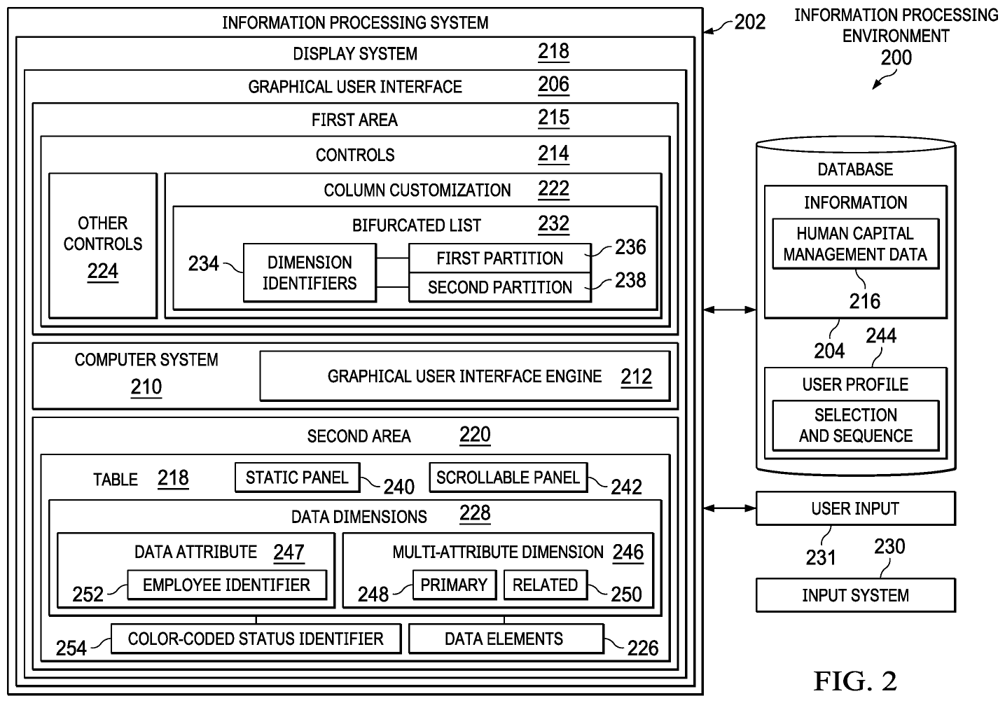

With reference now to FIG. 2, a block diagram of an information processing environment is depicted in accordance with an illustrative embodiment. In this illustrative example, information processing environment 200 includes components that can be implemented in hardware such as the hardware shown in network data processing system 100 in FIG. 1.

In this illustrative example, information processing system 202 operates to access and display information 204. Information processing system 202 can access and display information 204 for clients, selected from at least one of an organization, a company, an individual, a partnership, a charity, a city, or some other suitable type of client.

In this illustrative example, graphical user interface 206 can be used to more accurately access and display information 204 as compared to known graphical user interfaces.

Graphical user interface 206 solves the complex problem of displaying a massive data grid where many columns are interrelated. In one illustrative example, compensation data for company employees often have numerous parameters, fields, figures, and values that must be accessed and compared when performing human resource operations. Because of the large number of columns and rows in which relevant data is displayed, the user must often scroll tables of relevant information to display old data, new data, or comparative data.

Often, the absolute volume of information precludes a user from simultaneously viewing relevant information. Information displayed in disparate columns of multiple column grids can require a huge horizontal scroll, often hiding columns of information as new columns are scrolled into and out of view. For example, when the user scrolls to columns on the left side of a data grid, columns on the right side of the data grid are hidden under the scroll. The user cannot relate which row and label to refer as the primary detail is hidden by the scroll.

Graphical user interface 206 solves problems of known interfaces by enabling the user to access and display data values across user-customizable data dimensions. In one illustrative example, columns of interrelated information can be combined by the user, merging a plurality of columns into one column and helping the user to associate related data dimensions, and reduce the horizontal scroll of the data grid. In one illustrative example, different columns of information can be reordered within the data grid by the user to aid in comparison between relevant data dimensions. Additionally, different columns of information can be selectively appended within a static panel of the graphical user interface, enabling the user to scroll through other information without obscuring important data dimensions.

In this illustrative example, graphical user interface 206 is located in computer system 210. Computer system 210 is a physical hardware system and includes one or more data processing systems. When more than one data processing system is present in computer system 210, those data processing systems are in communication with each other using a communications medium. The communications medium may be a network. The data processing systems may be selected from at least one of a computer, a server computer, a tablet, or some other suitable data processing system.

As depicted, graphical user interface engine 212 in computer system 210 operates to generate graphical user interface 206 for use in displaying human capital management data 216 in graphical user interface 206. Graphical user interface engine 212 can be implemented in software, hardware, firmware or a combination thereof. When software is used, the operations performed by graphical user interface engine 212 can be implemented in program code configured to run on hardware, such as a processor unit. When firmware is used, the operations performed by graphical user interface engine 212 can be implemented in program code and data and stored in persistent memory to run on a processor unit. When hardware is employed, the hardware may include circuits that operate to perform the operations in graphical user interface engine 212.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Graphical user interface 206 is displayed on display system 218. Display system 218 is a physical hardware system and includes one or more display devices on which graphical user interface 206 can be displayed. The display devices can include at least one of a light emitting diode (LED) display, a liquid crystal display (LCD), an organic light emitting diode (OLED) display, a computer monitor, a projector, a flat panel display, a heads-up display (HUD), or some other suitable device that can output information for the visual presentation of information.

As depicted, graphical user interface 206 displays set of controls 214 in first area 215 of graphical user interface 206. As used herein, a control is a graphical and/or functional element that can be reused across graphical user interface (GUI) applications and which the user can select and activate to get additional information. A control, in a graphical user interface, is an object on the screen that can be manipulated by the user to perform some action. A button is a common type of control. In this illustrative example, controls 214 include column customization 222. Controls 214 can also include one or more other controls 224.

As depicted, graphical user interface 206 displays table 218 in second area 220 of graphical user interface 206. Table 218 comprises a set of data elements 226 displayed across a set of data dimensions 228.

In this illustrative example, data dimensions 228 are categories of data; data dimensions 228 provide structured labeling information for data elements 226. Data elements 226 are values of data dimensions 228 for a particular data entry.

A user can interact with graphical user interface 314 through user input 231 generated by input system 230, which is a physical hardware system. Input system 230 can be selected from at least one of a mouse, a keyboard, a trackball, a touchscreen, a stylus, a motion sensing input device, a cyber glove, or some other suitable type of input device. Display system 218 and input system 230 form a human machine interface (HMI).

Graphical user interface 206 displays bifurcated list 232 in response to receiving user input that selects the column customization 222. Bifurcated list 232 can be a graphical control, such as a drop-down list. In one illustrative example, bifurcated list 232 is a list of dimension identifiers 234. Each of the dimension identifiers 234 is a graphical control corresponding to a different one of the set of data dimensions 228 displayed in table 218.

A user can selectively move dimension identifiers 234 between first partition 236 and second partition 238 of bifurcated list 232. In response to receiving user input moving a dimension identifier to first partition 236 of bifurcated list 232, graphical user interface 206 displays the corresponding data dimension 228 in static panel 240 of second area 220 of graphical user interface 206. Data dimensions 228 displayed in static panel 240 do not scroll, or can be scrolled separately from data dimensions displayed in scrollable panel 242.

In response to receiving user input moving a dimension identifier to second partition 238 of bifurcated list 232, graphical user interface 206 displays the corresponding one of data dimensions 228 in scrollable panel 242 of the second area of the graphical user interface. Scrolling of data dimensions displayed in scrollable panel 242 does not affect the display of data dimensions 228 displayed in static panel 240.

In an illustrative example, a user can customize the order in which data dimensions 228 are displayed in table 218 by changing the sequence of dimension identifiers 234 in bifurcated list 232. A user can move one of dimension identifiers 234 within first partition 236 relative to other dimension identifiers in first partition 236. In response, graphical user interface engine 212 dynamically reorders ordering the corresponding data dimensions, causing graphical user interface 206 to display data dimensions 228 within static panel 240 according to the sequence of dimension identifiers 234 in first partition 236. A user can move one of dimension identifiers 234 within second partition 238 relative to other dimension identifiers in second partition 238. In response, graphical user interface engine 212 dynamically reorders ordering the corresponding data dimensions, causing graphical user interface 206 to display data dimensions 228 within scrollable panel 242 according to the sequence of dimension identifiers 234 in second partition 238.

In an illustrative example, a user can determine which data dimensions 228 are displayed in table 218 by selectively toggling dimension identifiers 234 in bifurcated list 232. In this illustrative example, each dimension identifiers 234 in bifurcated list 232 can be selectively viewed or hidden. For example, in response to receiving user input deselecting the dimension identifier within the bifurcated list, graphical user interface engine 212 dynamically removing the corresponding data dimension from the table, causing graphical user interface 206 to display table 218 without the data dimension corresponding to the deselected dimension identifier 234.

In an illustrative example, the selection and sequence of dimension identifiers 234 within bifurcated list 232 can be stored in user profile 244. When a subsequent user session is initiated, graphical user interface 206 displays table 218 according to the selection and sequence of dimension identifiers 234 indicated by user profile 244. By storing individual user preferences and separate profiles, different users can selectively view different information, focusing table 218 on those dimensions that are most relevant to the particular user.

In an illustrative example, one or more data dimensions 228 can be multi-attribute dimension 246. As used herein, an attribute is a data field, representing a characteristic or feature of a data object. While an attribute is similar to a dimension. However, as used herein, an attribute is a single data field, while a dimension can be a set of one or more attributes; a multi-attribute dimension is a set of two or more attributes.

In an illustrative example, the user can selectively configure multi-attribute dimension 246 by associating two or more data dimensions 228. Graphical user interface 206 enables a user to select primary data attribute 248, and related data attribute 250. In response to receiving user input of the selections, graphical user interface engine associates the related data attribute with the primary data attribute in a single multi-attribute dimension. Graphical user interface 206 displays the table of data in the second area across the multi-attribute dimension. The multi-attribute dimension displays a plurality of data values according to the selected data attributes.

In an illustrative example, data attribute 247 can be employee identifier 252. By default, employee identifier 252 can be displayed within static panel 240. However, employee identifier 252 can be selectively displayed within scrollable panel 242, for example by receiving appropriate user input to bifurcated list 232, as described above.

Continuing with the current example, graphical user interface 206 of can further decrease the footprint of table 218 by associating color-coded status identifier 254 with employee identifier 252. Instead of displaying an additional one of data dimensions 228, color-coded status identifier 254 represents data values 226 for a particular one of data dimensions 228 by displaying a status identifier in conjunction with a related one of data dimensions 228. For example, color-coded status identifier 254 may identify an employment status of an associated employee, and display the employment status identifier in conjunction with employee identifier 254. Graphical user interface 206 displays a color-coded status identifier in association with employee identifier 252, wherein color-coded status identifier 254 denotes a current employment status associated with corresponding data element.

When considered as a whole, the disclosed graphical user interface integrates processes into a specific method for accessing and displaying data values across user-customizable data dimensions in electronic spreadsheets. The illustrative embodiments provide a specific solution to technological problems in computers and prior art electronic computer spreadsheets are not user friendly. Graphical user interface 206 solves the complex problem of displaying a massive data grid where many columns are interrelated, enabling the user to access and display data values across user-customizable data dimensions. In one illustrative example, columns of interrelated information can be combined by the user, merging a plurality of columns into one column and helping the user to associate related data dimensions, and reduce the horizontal scroll of the data grid. In one illustrative example, different columns of information can be reordered within the data grid by the user to aid in comparison between relevant data dimensions.

Additionally, different columns of information can be selectively appended within a static panel of the graphical user interface, enabling the user to scroll through other information without obscuring important data dimensions. In one illustrative example, compensation data for company employees often have numerous parameters, fields, figures, and values that must be accessed and compared when performing human resource operations. Because of the large number of columns and rows in which relevant data is displayed, the user must often scroll tables of relevant information to display old data, new data, or comparative data.

Previous electronic computer spreadsheets often displayed Information in disparate columns of multiple column grids. Users are required to horizontal scroll through a huge amount of data, often hiding columns of information as new columns are scrolled into and out of view. For example, when the user scrolls to columns on the left side of a data grid, columns on the right side of the data grid are hidden under the scroll. The user cannot relate which row and label to refer as the primary detail is hidden by the scroll. The absolute volume of information precludes a user from simultaneously viewing and comparing relevant information using previously known spreadsheets.

Therefore, the illustrative embodiments are directed to an improved display interface that allowed users to more quickly access and compare stored data, thereby improving the efficient functioning of the computer. The invention thus increases the efficiency with which users access the various data dimensions.

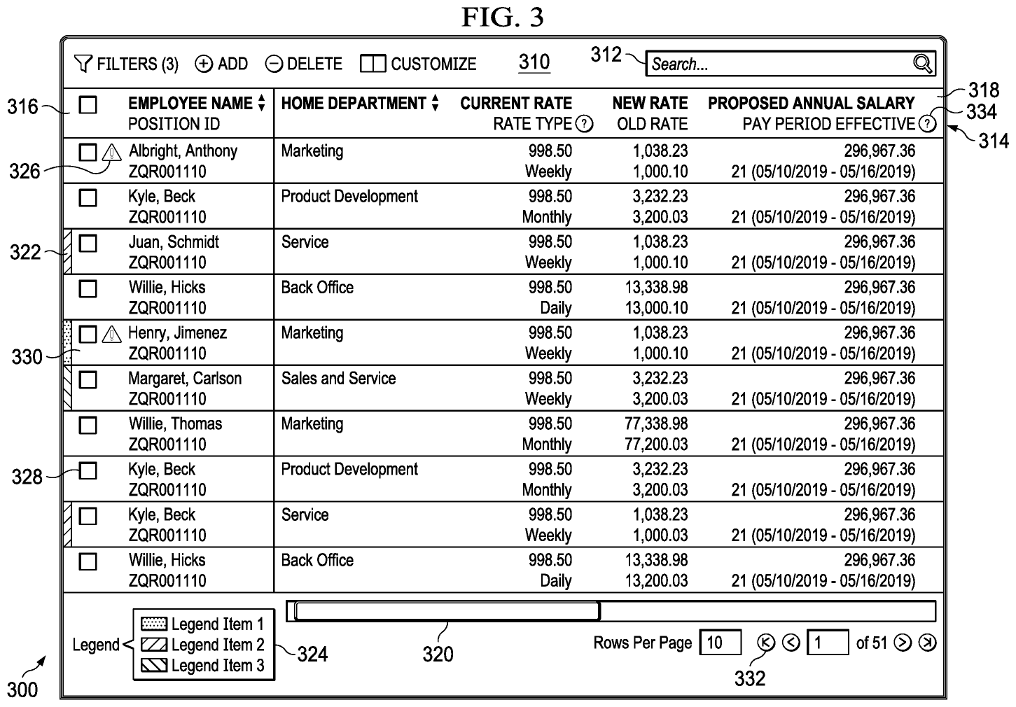

With reference next to FIG. 3, a first illustration of a graphical user interface is depicted in accordance with an illustrative embodiment. Graphical user interface 300 is an example of graphical user interface 206, illustrated in block form in FIG. 2.

Graphical user interface includes controls 310. Controls 310 are examples of controls 214 of FIG. 2. Controls 310 enable actions for managing content of the table grid, for example by filtering, adding, removing and customizing the columns and placements.

Graphical user interface 300 includes search bar 312. Search bar 312 enables the user to quickly search data from different parameters.

Column headers 314 of graphical user interface include a sorting function. Column headers 314 surely different data dimensions, which can be multi-attribute dimensions 246 of FIG. 2. As depicted, column headers 314 are multi-attribute dimensions showing two levels of data dimensions, with related dimensions being listed beneath the primary dimension.

Graphical user interface 300 includes static pane 316 and scrollable pane 318, which are examples of static pane 240 and scrollable pane 242 of FIG. 2. Columns in static pane 316 are columns that have been selectively frozen in place, while columns in scrollable pane 318 are horizontally scrollable, by interaction with scrollbar 320, to reveal additional columns that may be hidden.

Graphical user interface includes color-coded status identifier 322, which is an example of color-coded status identifier 254 of FIG. 2. As depicted, color-coded status identifier 322 appears as a colored block, representing different employment statuses for an associated employee. Different statuses can be further defined in legend 324.

In this illustrative example, graphical user interface 300 includes alert icon 326, associated with one or more different data values. Alert icon 326 enables graphical user interface 300 to draw a user's attention to the particular data entry.

In this illustrative example, graphical user interface 300 includes selectable boxes 328 associated with one or more rows. Selection of multiple selectable boxes 328 enables a user to perform a single action on each of the selected rows, such as a mass edit or deletion of the associated rows.

A focus can be set on different rows of graphical user interface. As depicted, a user has set focus on row 330 of graphical user interface 300. Focus can be set by receiving user input, such as a mouse over event, or tabbed selection of row 330.

In this illustrative example, graphical user interface 300 includes page control 332. As depicted, page control 322 is a control element that enables the user to increase or decrease the number of rows displayed on a page, as well cycling scrollable pane 318 to display hidden columns.

In this illustrative example, graphical user interface includes information icon 334 associated with one or more data dimensions. Information icon 334 can be selected, such as through a mouse click or mouse over event, to display additional information about the associated data dimension.

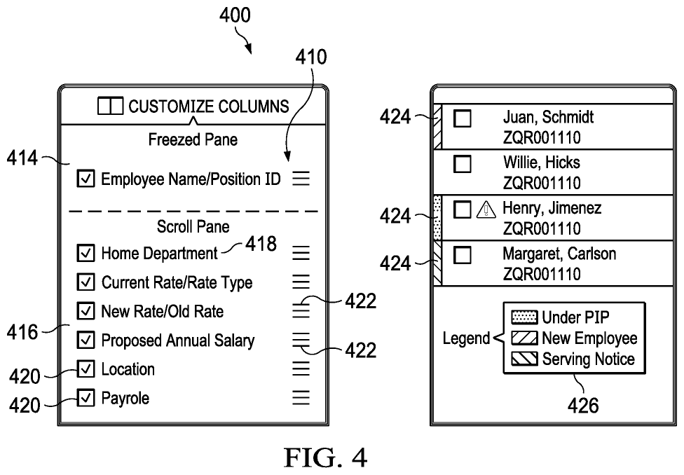

With reference next to FIG. 4, an illustration of different graphical control elements for a graphical user interface are depicted in accordance with an illustrative embodiment. The different graphical control elements can be implemented in conjunction with a graphical user interface, such as graphical user interface 300 of FIG. 3.

Graphical control elements 400 includes bifurcated list 410. Bifurcated list 410 is an example of bifurcated list 232 of FIG. 2. Bifurcated list 410 enables the sequence, selection, and grouping of the different data dimensions displayed in a table to be selectively configured. Through an appropriate user input, a user can selectively move dimension identifiers between first partition 414 and second partition 416, for example, using a drag-and-drop of the associated dimension identifier.

The sequence of dimension identifiers 418 can be selectively reconfigured to change the order in which data dimensions are displayed in a corresponding table. For example, dimension identifiers 418 can be reordered relative to other dimension identifiers in second partition 416 through an appropriate user input, for example, using a drag-and-drop of the associated dimension identifier, to reorder the sequence. For example, a user can move the column depending on the priority of the column data values. Changes made in a session are stored as part of the user profile, and are restored for the user's future sessions.

As depicted, display toggle 420 is associated with each dimension identifier 418. Display toggle 420 enables the selective viewing or hiding of an associated data dimension from the table. For example, a user can display or hide the associated column by selecting or deselecting the associated checkbox. The selection/deselection preference stored in the user profile for future login sessions.

As depicted, each dimension identifier 418 is associated with an attribute grouping control 422. Attribute grouping control 422 enables different dimension identifiers 418 to be grouped together, and thereby creating an association between two or more data dimensions into in a single multi-attribute dimension.

As depicted, a first multi-attribute dimension has been created from the “Employee Name” and “Position ID” data attributes; a second multi-attribute dimension has been created from the “Current Rate” and “Rate Type” data attributes; and a third multi-attribute dimension has been created from the “New Rate” and “Old Rate” data attributes. As depicted, “Employee Name”, “Current Rate,” and “New Rate” have been selected as primary data attributes, while “Position ID”, “Rate Type”, and “Old Rate” have been selected as related data attributes.

Graphical control elements 400 includes color-coded status identifiers 424. Color-coded status identifiers 424 are examples of color-coded status identifiers 322 of FIG. 3. In this illustrative example, color-coded status identifier 424 denotes a current employment status associated with corresponding data element.

Color-coded status identifier 424 represents data values for a particular data dimension. For example, in one illustrative example, each color represents the different status of each row with a very specific meaning as indicated in index 426. Color-coded status identifier 424 brings attention of user to the specific row. Additional information can be brought up regarding a status of a row indicated by particular current color, such as by positioning a cursor on the color bar.

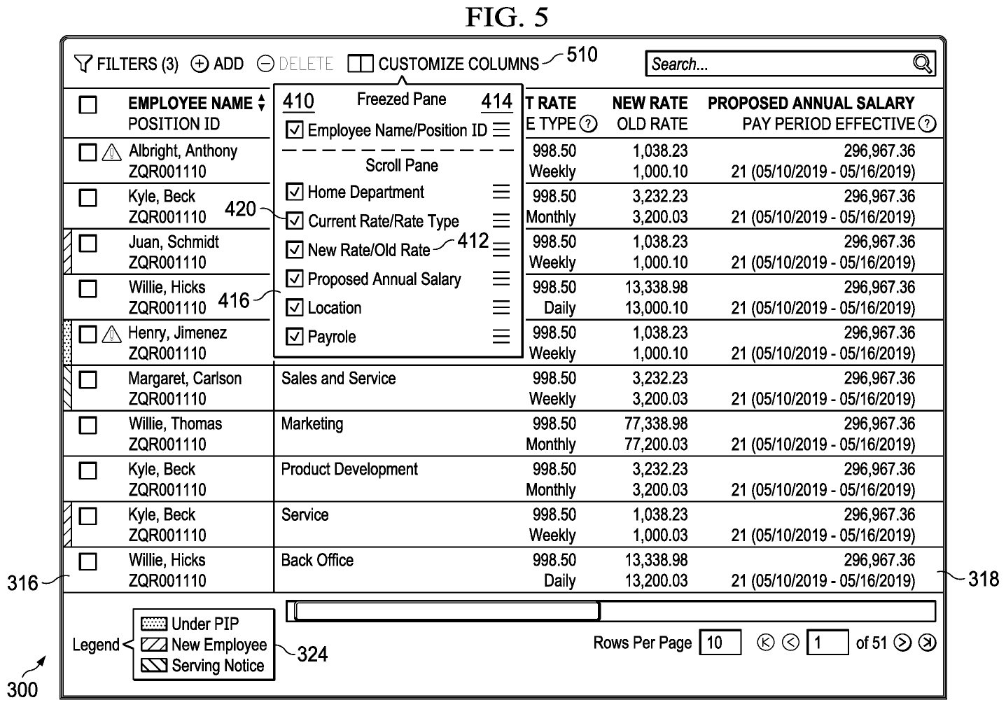

With reference next to FIG. 5, an illustration of different graphical control elements in context with a graphical user interface are depicted in accordance with an illustrative embodiment. In this illustrative example, graphical user interface 300 of FIG. 3.

In the illustrative examples, the same reference numeral may be used in more than one figure. This reuse of a reference numeral in different figures represents the same element in the different figures.

As depicted, graphical user interface 300 includes column customization 510 and bifurcated list 410. Column customization 510 is an example of column customization 222 of FIG. 2. In this illustrative example, bifurcated list 410 takes the form of a pop-up window, displayed in response to receiving user input that selects the column customization 510.

Graphical user interface 300 displays the different data dimensions in either static pane 316 or scrollable pane 318. First partition 414 corresponds to Static pane 316, such that data dimensions are displayed in static pane 316 based on the associated dimension being located in first partition 414. Second partition 416 corresponds to scrollable pane 318, such that data dimensions are displayed in scrollable pane 318 based on the associated dimension being located in second partition 416.

Graphical user interface engine 300 dynamically reorders the display order of data dimensions according to the sequence of dimension identifiers. As depicted, graphical user interface 300 displays data dimensions within the scrollable panel 318 according to the sequence of the dimension identifiers 412 in the second partition 416.

As depicted, each of display toggle 420 has been selected. Graphical user interface 300 displays all the data dimensions illustrated in bifurcated list 410, based on the selection of display toggles 420.

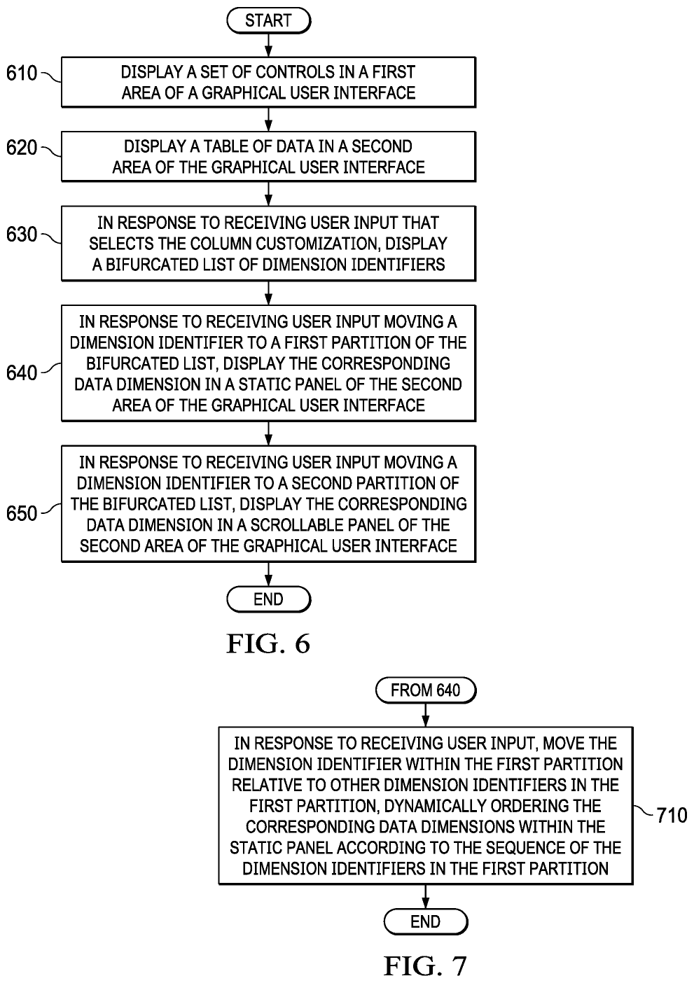

Turning next to FIG. 6, a flowchart of a process for accessing and displaying data values across user-customizable data dimensions is depicted according to an illustrative embodiment. The process of FIG. 6 can be implemented in hardware, software, or both. When implemented in software, the process can take the form program code that is run by one or more processor units located in one or more hardware devices in one or more computer systems. For example, the process can be implemented in a graphical user interface engine 212 in computer system 210 of FIG. 2.

The process begins by displaying a set of controls in a first area of a graphical user interface (step 610). The set of controls includes a column customization control, such as column customization 222 of FIG. 2.

The process displays a table of data in a second area of the graphical user interface (step 620). The table, which can be table 218 of FIG. 2, displays a set of data values across a set of data dimensions.

In response to receiving user input that selects the column customization, the process displays a bifurcated list of dimension identifiers (step 630). Each of the dimension identifiers corresponds to a different one of the set of data dimensions. The bifurcated list can be, for example, bifurcated list 232 of FIG. 2.

In response to receiving user input moving a dimension identifier to a first partition of the bifurcated list, the process displays the corresponding data dimension in a static panel of the second area of the graphical user interface (step 640). The static panel can be, for example, static panel 240 of FIG. 2.

In response to receiving user input moving a dimension identifier to a second partition of the bifurcated list, the process displays the corresponding data dimension in a scrollable panel of the second area of the graphical user interface (step 650), with the process terminating thereafter. The scrollable panel can be, for example, scrollable panel 242 of FIG. 2.

Turning next to FIG. 7, a flowchart of additional processing steps for accessing and displaying data values across user-customizable data dimensions is depicted according to an illustrative embodiment. Process 700 and be implemented in conjunction with process 600 FIG. 6.

Continuing from step 640, in response to receiving user input moving the dimension identifier within the first partition relative to other dimension identifiers in the first partition, the process dynamically orders the corresponding data dimensions within the static panel according to the sequence of the dimension identifiers the first partition (step 710), with the process terminating thereafter.

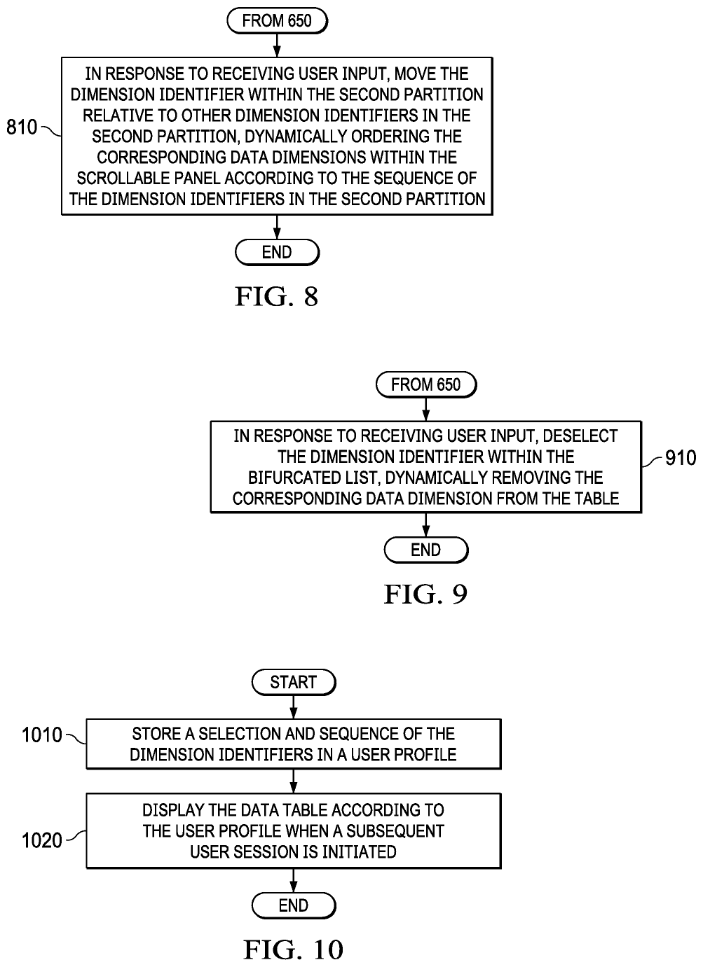

Turning next to FIG. 8, a flowchart of additional processing steps for accessing and displaying data values across user-customizable data dimensions is depicted according to an illustrative embodiment. Process 800 and be implemented in conjunction with process 600 FIG. 6.

Continuing from step 650, in response to receiving user input moving the dimension identifier within the second partition relative to other dimension identifiers in the second partition, the process dynamically orders the corresponding data dimensions within the scrollable panel according to the sequence of the dimension identifiers the second partition (step 810), with the process terminating thereafter.

Turning next to FIG. 9, a flowchart of additional processing steps for accessing and displaying data values across user-customizable data dimensions is depicted according to an illustrative embodiment. Process 900 and be implemented in conjunction with process 600 FIG. 6.

Continuing from step 650, in response to receiving user input deselecting the dimension identifier within the bifurcated list, the process dynamically removes the corresponding data dimension from the table (step 910), with the process terminating thereafter.

Turning next to FIG. 10, a flowchart of additional processing steps for accessing and displaying data values across user-customizable data dimensions is depicted according to an illustrative embodiment. Process 1000 and be implemented in conjunction with process 600 FIG. 6.

Continuing from step 650, the process stores a selection and sequence of the dimension identifiers. The user profile (step 1010). The user profile can be, for example, user profile 244 of FIG. 2. Sometime thereafter, the process displays the data table according to the user profile. When a subsequent user session is initiated (step 1020).

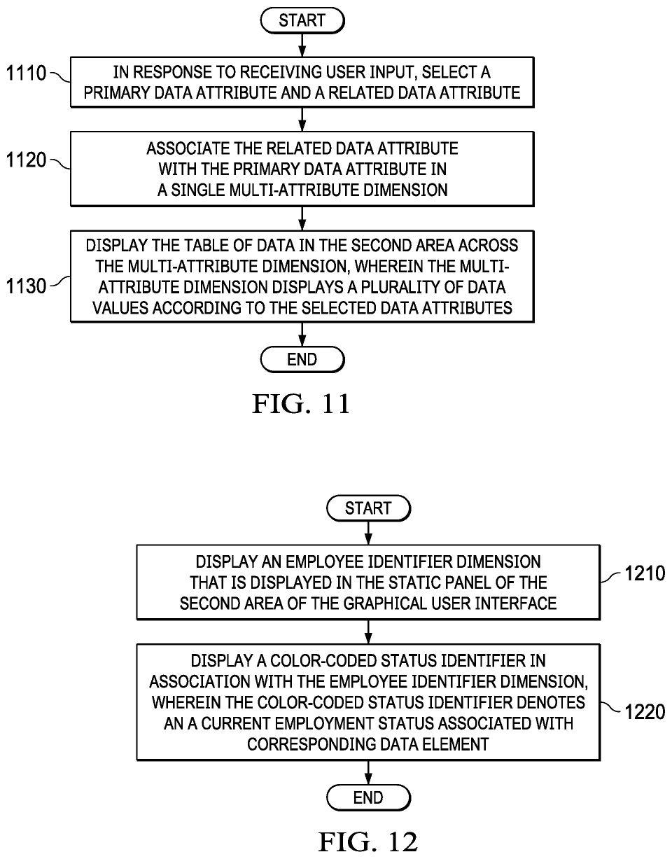

Turning next to FIG. 11, a flowchart of additional processing steps for accessing and displaying data values across user-customizable data dimensions is depicted according to an illustrative embodiment. Process 1100 and be implemented in conjunction with process 600 FIG. 6.

Continuing from step 650, the process receives a selection of a primary data attribute and a related data attribute (step 1110). The primary data attribute and related data attribute can be, for example, primary attributes 248 and related attribute 250 of FIG. 2, respectively.

The process associates the related data attribute with the primary data attribute in a multi-attribute dimension (step 1120). The multi-attribute dimension can be, for example, multi-attribute dimension 246 of FIG. 2.

The process then displays the table of data. The second area across the multi-attribute dimension (step 1130), the process terminating thereafter. The multi-attribute dimension displays a plurality of data values according to the selected data attributes.

Turning next to FIG. 12, a flowchart of additional processing steps for accessing and displaying data values across user-customizable data dimensions is depicted according to an illustrative embodiment. Process 1200 and be implemented in conjunction with process 600 of FIG. 6.

Continuing from step 620, the process displays an employee identifier dimension in a static panel of the second area graphical user interface (step 1210). The employee identifier is an example of a data dimension, and can be employee identifier 252 of FIG. 2.

The process displays a color-coded status identifier in association with the employee identifier dimension (step 1220). The color-coded status identifier, which can be color-coded status identifier 254 of FIG. 2, denotes a current employment status associated corresponding data element second area of the graphical user interface. The process can continue to step 630 thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

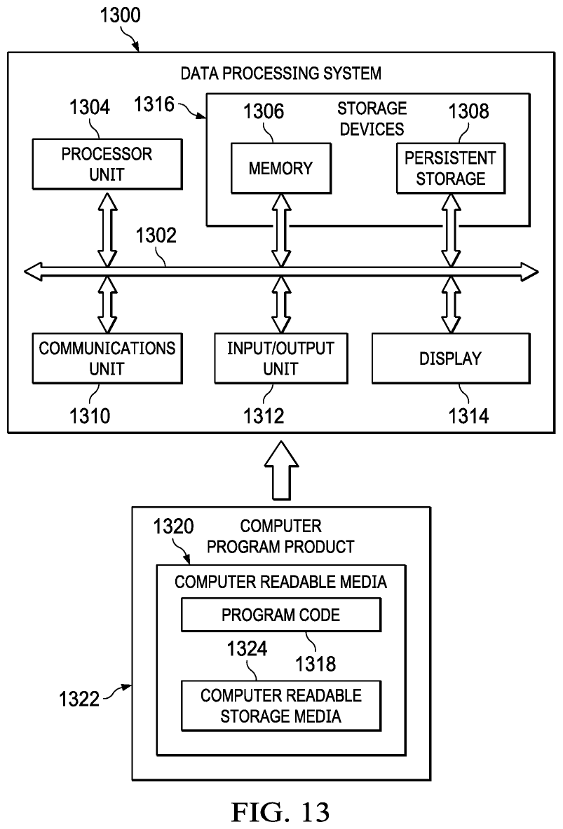

Turning now to FIG. 13, a block diagram of a data processing system is depicted in accordance with an illustrative embodiment. Data processing system 1300 can be used to implement server computer 104, server computer 106, and client devices 110 in FIG. 1. Data processing system 1300 can also be used to implement one or more data processing systems in computer system 210 in FIG. 2. In this illustrative example, data processing system 1300 includes communications framework 1302, which provides communications between processor unit 1304, memory 1306, persistent storage 1308, communications unit 1310, input/output (I/O) unit 1312, and display 1314. In this example, communications framework 1302 takes the form of a bus system.

Processor unit 1304 serves to execute instructions for software that can be loaded into memory 1306. Processor unit 1304 includes one or more processors. For example, processor unit 1304 can be selected from at least one of a multicore processor, a central processing unit (CPU), a graphics processing unit (GPU), a physics processing unit (PPU), a digital signal processor (DSP), a network processor, or some other suitable type of processor.

Memory 1306 and persistent storage 1308 are examples of storage devices 1316. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1316 may also be referred to as computer-readable storage devices in these illustrative examples. Memory 1306, in these examples, can be, for example, a random-access memory or any other suitable volatile or non-volatile storage device. Persistent storage 1308 may take various forms, depending on the particular implementation.

For example, persistent storage 1308 may contain one or more components or devices. For example, persistent storage 1308 can be a hard drive, a solid-state drive (SSD), a flash memory, a rewritable optical disk, a rewritable magnetic tape, or some combination of the above. The media used by persistent storage 1308 also can be removable. For example, a removable hard drive can be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that can be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs can be located in storage devices 1316, which are in communication with processor unit 1304 through communications framework 1302. The processes of the different embodiments can be performed by processor unit 1304 using computer-implemented instructions, which may be located in a memory, such as memory 1306.

These instructions are referred to as program code, computer usable program code, or computer-readable program code that can be read and executed by a processor in processor unit 1304. The program code in the different embodiments can be embodied on different physical or computer-readable storage media, such as memory 1306 or persistent storage 1308.

Program code 1318 is located in a functional form on computer-readable media 1320 that is selectively removable and can be loaded onto or transferred to data processing system 1300 for execution by processor unit 1304. Program code 1318 and computer-readable media 1320 form computer program product 1322 in these illustrative examples. In the illustrative example, computer-readable media 1320 is computer-readable storage media 1324.

In these illustrative examples, computer-readable storage media 1324 is a physical or tangible storage device used to store program code 1318 rather than a medium that propagates or transmits program code 1318.

Alternatively, program code 1318 can be transferred to data processing system 1300 using a computer-readable signal media. The computer-readable signal media can be, for example, a propagated data signal containing program code 1318. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1320” can be singular or plural. For example, program code 1318 can be located in computer-readable media 1320 in the form of a single storage device or system. In another example, program code 1318 can be located in computer-readable media 1320 that is distributed in multiple data processing systems. In other words, some instructions in program code 1318 can be located in one data processing system while other instructions in in program code 1318 can be located in one data processing system. For example, a portion of program code 1318 can be located in computer-readable media 1320 in a server computer while another portion of program code 1318 can be located in computer-readable media 1320 located in a set of client computers.

The different components illustrated for data processing system 1300 are not meant to provide architectural limitations to the manner in which different embodiments can be implemented. The different illustrative embodiments can be implemented in a data processing system including components in addition to or in place of those illustrated for data processing system 1300. Other components shown in FIG. 13 can be varied from the illustrative examples shown. The different embodiments can be implemented using any hardware device or system capable of running program code 1318.

The description of the different illustrative embodiments has been presented for purposes of illustration and description and is not intended to be exhaustive or limited to the embodiments in the form disclosed. In some illustrative examples, one or more of the components may be incorporated in or otherwise form a portion of, another component. For example, the 1306, or portions thereof, may be incorporated in processor unit 1304 in some illustrative examples. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A method for accessing and displaying data values across user-customizable data dimensions, the method comprising:
displaying a set of controls in a first area of a graphical user interface engine, wherein the set of controls comprises a column customization;
displaying a table of data in a second area of the graphical user interface engine, wherein the table comprises a set of data values displayed across a set of data dimensions;
in response to receiving user input that selects the column customization, displaying a bifurcated list of dimension identifiers, wherein each of the dimension identifiers corresponds to a different one of the set of data dimensions;
in response to receiving user input moving a dimension identifier to a first partition of the bifurcated list, displaying a corresponding static data dimension and a first sub-set of data values in a static panel of the second area of the graphical user interface engine; and
in response to receiving user input moving a dimension identifier to a second partition of the bifurcated list, displaying a corresponding scrollable data dimension and a second sub-set of data values in a scrollable panel of the second area of the graphical user interface engine.

2. The method of claim 1, further comprising:
in response to receiving user input moving the dimension identifier within the first partition relative to other dimension identifiers in the first partition, dynamically ordering the corresponding data dimensions within the static panel according to a sequence of the dimension identifiers in the first partition.

3. The method of claim 1, further comprising:
in response to receiving user input moving the dimension identifier within the second partition relative to other dimension identifiers in the second partition, dynamically ordering the corresponding data dimensions within the scrollable panel according to a sequence of the dimension identifiers in the second partition.

4. The method of claim 1, further comprising:
in response to receiving user input deselecting the dimension identifier within the bifurcated list, dynamically removing a corresponding data dimension from the table.

5. The method of claim 1, further comprising:
storing a selection and sequence of the dimension identifiers in a user profile; and
displaying the data table according to the user profile when a subsequent user session is initiated.

6. The method of claim 1, wherein the data dimensions are multi-attribute dimensions, the method further comprising:
in response to receiving user input selecting a primary data attribute and a related data attribute;
associating the related data attribute with the primary data attribute in a single multi-attribute dimension; and
displaying the table of data in the second area across the multi-attribute dimension, wherein the multi-attribute dimension displays a plurality of data values according to the selected data attributes.

7. The method of claim 1, further comprising:
displaying an employee identifier dimension that is displayed in the static panel of the second area of the graphical user interface engine; and
displaying a color-coded status identifier in association with the employee identifier dimension, wherein the color-coded status identifier denotes a current employment status associated with corresponding data element.

8. A computer system for accessing and displaying data values across user-customizable data dimensions, the computer system comprising:
a hardware processor;
a display device; and
a graphical user interface engine implemented by the hardware processor, wherein the graphical user interface engine is configured to control the display device:
to display a set of controls in a first area of a graphical user interface engine, wherein the set of controls comprises a column customization;
to display a table of data in a second area of the graphical user interface engine, wherein the table comprises a set of data values displayed across a set of data dimensions;
in response to receiving user input that selects the column customization, to display a bifurcated list of dimension identifiers, wherein each of the dimension identifiers corresponds to a different one of the set of data dimensions;
in response to receiving user input moving a dimension identifier to a first partition of the bifurcated list, to display a corresponding static data dimension and a first sub-set of data values in a static panel of the second area of the graphical user interface engine; and
in response to receiving user input moving a dimension identifier to a second partition of the bifurcated list, to display a corresponding scrollable data dimension and a second sub-set of data values in a scrollable panel of the second area of the graphical user interface engine.

9. The computer system of claim 8, wherein the graphical user interface engine is configured:
in response to receiving user input moving the dimension identifier within the first partition relative to other dimension identifiers in the first partition, to dynamically order the corresponding data dimensions within the static panel according to a sequence of the dimension identifiers in the first partition.

10. The computer system of claim 8, wherein the graphical user interface engine is configured:
in response to receiving user input moving the dimension identifier within the second partition relative to other dimension identifiers in the second partition, to dynamically order the corresponding data dimensions within the scrollable panel according to a sequence of the dimension identifiers in the second partition.

11. The computer system of claim 8, wherein the graphical user interface engine is configured:
in response to receiving user input deselecting a dimension identifier within the bifurcated list, to dynamically remove the corresponding data dimension from the table.

12. The computer system of claim 8, wherein the computer system is configured:
to store a selection and sequence of the dimension identifiers in a user profile; and
wherein the graphical user interface engine is configured:
displaying the data table according to the user profile when a subsequent user session is initiated.

13. The computer system of claim 8, wherein the data dimensions are multi-attribute dimensions, wherein the graphical user interface engine is further configured:
to receiving user input selecting a primary data attribute and a related data attribute;
to associate the related data attribute with the primary data attribute in a single multi-attribute dimension; and
to control the display system to display the table of data in the second area across the multi-attribute dimension, wherein the multi-attribute dimension displays a plurality of data values according to the selected data attributes.

14. The computer system of claim 8, wherein the graphical user interface engine is configured to control the display device:
to display an employee identifier dimension that is displayed in the static panel of the second area of the graphical user interface engine; and
to display a color-coded status identifier in association with the employee identifier dimension, wherein the color-coded status identifier denotes a current employment status associated with corresponding data element.

15. A computer program product comprising:
a non-transitory computer readable storage media; and
program code, stored on the computer readable storage media, for accessing and displaying data values across user-customizable data dimensions, the program code comprising:
program code for displaying a set of controls in a first area of a graphical user interface engine implemented by a hardware processor, wherein the set of controls comprises a column customization;
program code for displaying a table of data in a second area of the graphical user interface engine, wherein the table comprises a set of data values displayed across a set of data dimensions;
program code for displaying a bifurcated list of dimension identifiers in response to receiving user input that selects the column customization, wherein each of the dimension identifiers corresponds to a different one of the set of data dimensions;
program code for displaying a corresponding static data dimension and a first sub-set of data values in a static panel of the second area of the graphical user interface engine in response to receiving user input moving a dimension identifier to a first partition of the bifurcated list; and
program code for displaying a corresponding scrollable data dimension and a second sub-set of data values in a scrollable panel of the second area of the graphical user interface engine in response to receiving user input moving a dimension identifier to a second partition of the bifurcated list.

16. The computer program product of claim 15, wherein the program code further comprises:
program code for dynamically ordering the corresponding data dimensions within the static panel according to a sequence of the dimension identifiers in the first partition in response to receiving user input moving the dimension identifier within the first partition relative to other dimension identifiers in the first partition.

17. The computer program product of claim 15, wherein the program code further comprises:
program code for dynamically ordering the corresponding data dimensions within the scrollable panel according to a sequence of the dimension identifiers in the second partition in response to receiving user input moving the dimension identifier within the second partition relative to other dimension identifiers in the second partition.

18. The computer program product of claim 15, wherein the program code further comprises:
program code for dynamically removing a corresponding data dimension from the table in response to receiving user input deselecting the dimension identifier within the bifurcated list.

19. The computer program product of claim 15, wherein the program code further comprises:
program code for storing a selection and sequence of the dimension identifiers in a user profile; and
program code for displaying the data table according to the user profile when a subsequent user session is initiated.

20. The computer program product of claim 15, wherein the data dimensions are multi-attribute dimensions, wherein the program code further comprises:
program code for associating a related data attribute with the primary data attribute in a single multi-attribute dimension in response to receiving user input selecting a primary data attribute and a related data attribute; and
program code for displaying the table of data in the second area across the multi-attribute dimension, wherein the multi-attribute dimension displays a plurality of data values according to the selected data attributes.

21. The computer program product of claim 15, wherein the program code further comprises:
program code for displaying an employee identifier dimension that is displayed in the static panel of the second area of the graphical user interface engine; and
program code for displaying a color-coded status identifier in association with the employee identifier dimension, wherein the color-coded status identifier denotes a current employment status associated with corresponding data element.
